(19) United States
(12) Patent Application Publication
(10) Pub. No.: US 2026/0065480 A1
(43) Pub. Date: Mar. 5, 2026

(54) METHODS FOR DETERMINING AORTIC DISEASE SEVERITY USING STATISTICAL SHAPE MODELING AND UNIVERSAL COORDINATE SYSTEM MESH ANALYSIS

(71) Applicant: REGENTS OF THE UNIVERSITY OF MICHIGAN, Ann Arbor, MI (US)

(72) Inventors: Nicholas S. Burris, Ann Arbor, MI (US); Carlos Alberto Campello Jorge, Ann Arbor, MI (US); Prabhvir Singh Marway, Ann Arbor, MI (US); Timothy Baker, Ann Arbor, MI (US); David Nordsletten, Ann Arbor, MI (US)

(21) Appl. No.: 19/314,478

(22) Filed: Aug. 29, 2025

Related U.S. Application Data
(60) Provisional application No. 63/689,567, filed on Aug. 30, 2024.

(51) Int. Cl. G06T 7/00; G06T 7/11; G06T 17/20

(52) U.S. Cl. CPC G06T 7/0014; G06T 7/11; G06T 17/20; G06T 2207/30101; G06T 2207/30172

(57) ABSTRACT

Systems and methods for classifying an aortic condition include capturing aorta image data, applying a mesh generation process, and determining an intrinsic coordinate system for the resulting mesh structure, including a plurality of vertices. The mesh structure is mapped to a reference coordinate system for generating, from the vertices, mapped vertices, which are embedded into the mesh structure to create an embedded mesh structure. The embedded mesh structure is compared to reference mesh structures including at least one normal aortic mesh structure and at least one pathology aortic mesh structure, and a similarity score is generated, and the aortic condition is classified.

### CROSS-REFERENCE TO RELATED APPLICATIONS

This application claims the priority benefit under 35 U.S.C. § 119(e) of U.S. Provisional Application No. 63/689,567, filed Aug. 30, 2024, which is incorporated herein by reference in its entirety.

### FIELD OF THE DISCLOSURE

The present disclosure relates to identifying health conditions and, more particularly, to techniques for classifying an aortic condition of a patient using an aorta image data of a patient.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Ascending thoracic aortic aneurysm (aTAA) is characterized by the abnormal bulging or weakening of the ascending aorta's vessel wall. Current diagnostic methods for evaluating aortic conditions, particularly aTAA, primarily rely on measuring the maximal diameter of the aorta. However, the aorta's shape and size vary significantly among individuals, influenced by factors such as age, body size, inherent morphological features, and gender. As a result, using maximal diameter alone as a diagnostic criterion for aTAA is often inadequate, especially in patients with borderline ascending aortic dilation.

Moreover, treatment options for aTAA are typically determined based on the maximal diameter of the aorta. For instance, patients with an aortic diameter of less than 5.5 cm may be recommended conservative measures, such as lifestyle modifications or blood pressure management, while those with a diameter greater than 5.5 cm may be considered for surgical intervention. However, given the variation in aortic morphology across different individuals, relying solely on maximal diameter to guide treatment decisions is insufficient and may not accurately reflect the severity of the condition in some patients.

Therefore, there is a need for improved methods for diagnosing and/or treating aortic conditions.

### SUMMARY OF THE INVENTION

In some aspects, the techniques described herein relate to a method for classifying an aortic condition of a patient from aorta image data of a patient, the method including: applying, by one or more processors, the aorta image data to a mesh generator to generate a mesh structure of an aorta of the patient; determining, by the one or more processors, an intrinsic coordinate system for the mesh structure and determining a plurality of vertices corresponding to the intrinsic coordinate system; mapping, by the one or more processors, the mesh structure to a reference coordinate system and generating, from the plurality of vertices corresponding to the intrinsic coordinate system, a plurality of mapped vertices corresponding to the reference coordinate system; embedding, by the one or more processors, the plurality of mapped vertices into the mesh structure to create an embedded mesh structure; comparing, by the one or more processors, the embedded mesh structure to a plurality of reference mesh structures including at least one normal aortic mesh structure and at least one pathology aortic mesh structure, where each of the plurality of reference mesh structures correspond to the reference coordinate system, and generating a similarity score indicating a similarity of the embedded mesh structure to at least one of the plurality of reference mesh structures; and based on the similarity score, classifying, by the one or more processors, the aortic condition of the patient.

In some aspects, the techniques described herein relate to a method, wherein determining the mesh structure further includes: segmenting, by the one or more processors, the aorta image data of a patient using a segmentation model to determine a segmented aorta image data; and applying, by the one or more processors, the segmented aorta image data into the mesh generator to determine the mesh structure.

In some aspects, the techniques described herein relate to a method, wherein generating the mesh structure further includes: applying, by the one or more processors, a surface smoothing algorithm to the mesh structure; and applying, by the one or more processors, a down-sampling algorithm to the mesh structure.

In some aspects, the techniques described herein relate to a method, further including: applying, by the one or more processors, a centerline algorithm to the mesh structure to determine an initial mesh centerline; implementing, by the one or more processors, post-processing algorithms to the initial mesh centerline to determine a mesh centerline; and projecting, by the one or more processors, data of the mesh centerline into the mesh structure.

In some aspects, the techniques described herein relate to a method, wherein the applying the centerline algorithm to the mesh structure to determine the initial mesh centerline further includes: determining, by the one or more processors, a Voronoi diagram of the mesh structure; calculating, by the one or more processors, a maximum inscribed sphere for each polyhedron of the Voronoi diagram; connecting, by the one or more processors, radii of the maximum inscribed spheres; and identifying, by the one or more processors, the initial mesh centerline by using a shortest path algorithm to identify a shortest path through the radii of the maximum inscribed spheres from one extremal point to another extremal point.

In some aspects, the techniques described herein relate to a method, wherein the intrinsic coordinate system includes a distance to a closest centerline point (r), an angle normal to the closest centerline point (a), and a longitudinal position along the closest centerline point (h).

In some aspects, the techniques described herein relate to a method, wherein the reference coordinate system is a Cartesian coordinate system.

In some aspects, the techniques described herein relate to a method, further including: determining, by the one or more processors, a first ratio score using the aorta image data of the patient.

In some aspects, the techniques described herein relate to a method, wherein determining the first ratio score further includes: determining, by the one or more processors, a diameter of a mid-ascending aorta of the aorta image data of a patient and a diameter of sinuses of the aorta image data of a patient; and calculating, by the one or more processors, the first ratio score based on the diameter of a mid-ascending aorta and the diameter of sinuses.

In some aspects, the techniques described herein relate to a method, further including: classifying, by the one or more processors, the aortic condition of the patient of the patient based on the similarity score and/or the first ratio score.

In some aspects, the techniques described herein relate to a method, further including: determining, by the one or more processors, a second ratio score using the aorta image data, wherein the second ratio score is determined based on the diameter of a mid-ascending aorta and a body surface area of the patient; and classifying, by the one or more processors, the aortic condition of the patient based on the similarity score, the first ratio score, and/or the second ratio score.

In some aspects, the techniques described herein relate to a method, further including: scaling, by the one or more processors, the similarity score to be in a predefined range of numbers; and classifying, by the one or more processors, the aortic condition of the patient based on the scaled similarity score.

In some aspects, the techniques described herein relate to a computer system for classifying an aortic condition of a patient from aorta image data of a patient including: one or more processors; and a non-transitory program memory coupled to the one or more processors and storing executable instructions that, when executed by the one or more processors, causes the computer system to: apply the aorta image data to a mesh generator to generate a mesh structure of an aorta of the patient; determine an intrinsic coordinate system for the mesh structure and determining a plurality of vertices corresponding to the intrinsic coordinate system; map the mesh structure to a reference coordinate system and generate, from the plurality of vertices corresponding to the intrinsic coordinate system, a plurality of mapped vertices corresponding to the reference coordinate system; embed the plurality of mapped vertices into the mesh structure to create an embedded mesh structure; compare the embedded mesh structure to a plurality of reference mesh structures including at least one normal aortic mesh structure and at least one pathology aortic mesh structure, where each of the plurality of reference mesh structures correspond to the reference coordinate system, and generate a similarity score indicating a similarity of the embedded mesh structure to at least one of the plurality of reference mesh structures; and based on the similarity score, classify the aortic condition of the patient.

In some aspects, the techniques described herein relate to a computer system, wherein the instructions, when executed by the one or more processors, further cause the computer system to: segment the aorta image data of a patient using a segmentation model to determine a segmented aorta image data; and apply the segmented aorta image data into the mesh generator to determine the mesh structure.

In some aspects, the techniques described herein relate to a computer system, wherein the instructions, when executed by the one or more processors, further cause the computer system to: apply a surface smoothing algorithm to the mesh structure; and apply a down-sampling algorithm to the mesh structure.

In some aspects, the techniques described herein relate to a computer system, wherein the instructions, when executed by the one or more processors, further cause the computer system to: applying a centerline algorithm to the mesh structure to determine an initial mesh centerline; implement post-processing algorithms to the initial mesh centerline to determine a mesh centerline; and projecting data of the mesh centerline into the mesh structure.

In some aspects, the techniques described herein relate to a computer system, wherein the instructions, when executed by the one or more processors, further cause the computer system to: determine a first ratio score using the aorta image data of the patient.

In some aspects, the techniques described herein relate to a computer system, wherein the instructions, when executed by the one or more processors, further cause the computer system to: determine a diameter of a mid-ascending aorta of the aorta image data of a patient and a diameter of sinuses of the aorta image data of a patient; and calculate the first ratio score based on the diameter of a mid-ascending aorta and the diameter of sinuses.

In some aspects, the techniques described herein relate to a computer system, wherein the instructions, when executed by the one or more processors, further cause the computer system to: classify the aortic condition of the patient of the patient based on the similarity score and/or the first ratio score.

In some aspects, the techniques described herein relate to a computer system, wherein the instructions, when executed by the one or more processors, further cause the computer system to: determine a second ratio score using the aorta image data, wherein the second ratio score is determined based on the diameter of a mid-ascending aorta and a body surface area of the patient; and classify the aortic condition of the patient based on the similarity score, the first ratio score, and/or the second ratio score.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A is a schematic diagram illustrating the implementation of classifying an aortic condition.

FIG. 1B is a block diagram of a condition classifier server, in accordance with various aspects of the present disclosure.

FIG. 2 depicts a flow diagram of a process for determining a similarity score, in accordance with various aspects of the present disclosure.

FIG. 3 depicts images of different aortic conditions with different similarity scores, in accordance with various aspects of the present disclosure.

FIG. 4A shows a plot illustrating different aortic conditions based on an aortic size index (ASI) score and a similarity score, in accordance with various aspects of the present disclosure.

FIG. 4B shows a plot illustrating different aortic conditions based on an aortic size index (ASI) score, a similarity score, and a mid-ascending to sinus (M/S) ratio score.

FIG. 5 depicts images of an aorta with root, in accordance with various aspects of the present disclosure.

FIG. 6 illustrates a Voronoi diagram, in accordance with various aspects of the present disclosure.

FIG. 7 demonstrates an intrinsic coordinate system of an aorta, in accordance with various aspects of the present disclosure.

FIG. 8 demonstrates mean aortic shapes for different groups of patients and interquartile range graphs (IQR) of the max diameter and SSM score stratified by the different groups, in accordance with various aspects of the present disclosure.

FIG. 9 depicts a flow diagram of an example method for classifying an aortic condition, in accordance with various aspects of the present disclosure.

FIG. 10 depicts a flow diagram of another example process for determining a similarity score, in accordance with various aspects of the present disclosure.

### DETAILED DESCRIPTION

Broadly speaking, the techniques of the present disclosure relate to an improved method of classifying an aortic condition of a patient that receives an aorta image data from a patient, generate a mesh structure of the aorta image data, map the mesh structure to an intrinsic coordinate system (e.g., Universal Aortic Coordinate System), use the mapped mesh structure to determine a similarity score, and use the determined similarity score to classify an aortic condition of a patient. In this manner, the technique of the present disclosure classifies the aortic condition of a patient using a similarity score that accounts for the overall shape of the aorta. Additionally, the technique of the present disclosure standardizes the locations (e.g., mid-ascending aorta, roots, etc.) of different mesh structures using the intrinsic coordinate system. These techniques therefore improve over conventional techniques at least by standardizing different mesh structures with different local coordinates using the novel intrinsic coordinate system that enables the techniques of the present disclosure to correctly identify different parts of the mesh structure (identifying comparable vertices between different mesh structures of different patients), efficiently determine a similarity score, and significantly improve the accuracy of the similarity score.

As previously mentioned, conventional techniques do not account for the overall shape of the aorta when determining the aortic condition of a patient, accounting only the maximal diameter of a patient when determining the aortic condition. These conventional techniques therefore experience significant issues, such as inaccurate diagnosis of an aortic condition of a patient, or when determining treatment options for patients who are already diagnosed with aTTA. For instance, a patient with a structurally different but healthy aorta might be incorrectly diagnosed with an aortic condition based solely on the maximal diameter, when in reality, the larger size is due to natural anatomical variation rather than disease.

By contrast, the techniques of the present disclosure overcome these challenges of conventional techniques and thereby provide multiple technical advantages over such conventional techniques. For instance, the development of a novel intrinsic coordinate system enables the standardization of mesh structures taken from different orientations, of varying sizes, and of varying local coordinate systems. This standardization enables the system to more efficiently and accurately identify specific regions of the aorta with abnormal shape features, such as bulging. As a result, the techniques of the present disclosure can generate a more precise similarity score, leading to a more accurate classification of the aortic condition.

Moreover, the techniques of the present disclosure determine the similarity score based on shape analysis of the aorta, comparing the mesh structure of a patient with normal and pathological mesh structures. Therefore, through analyzing the shapes of the aorta, the techniques of the present disclosure look at overall shapes of the aorta instead focusing its attention to maximal diameter of the aorta. By focusing on the overall shape of the aorta rather than just its maximal diameter, the techniques of the present disclosure provide a more accurate classification of the aortic condition. This approach not only improves diagnostic accuracy but also enhances the ability to assess the severity of the condition (e.g., normal, mild dilation, aneurysm) and determine more appropriate treatment options.

The techniques of the present disclosure thus improve the functionality of a computing device (e.g., a hosting server such as a central server) at least by developing and using a novel intrinsic coordinate system that standardizes the mesh structures, and using the mapped mesh structures for shape analysis to determine a similarity score that is used to classify an aortic condition. Unlike conventional techniques that rely solely on a maximal aortic diameter, this disclosure standardizes the mesh structures and evaluates the entire shape of the aorta for classification. That is, the present disclosure describes improvements in the functioning of the computer itself because the computing device more efficiently and qualitatively analyzes the aortic image data by standardizing mesh structure to thereby come up with better and faster shape analysis of the aortic image data. This therefore improves over the prior art at least because existing systems typically focus on finding the maximal diameter across different aortic images with different orientations and sizes, often resulting in reduced efficiency and accuracy.

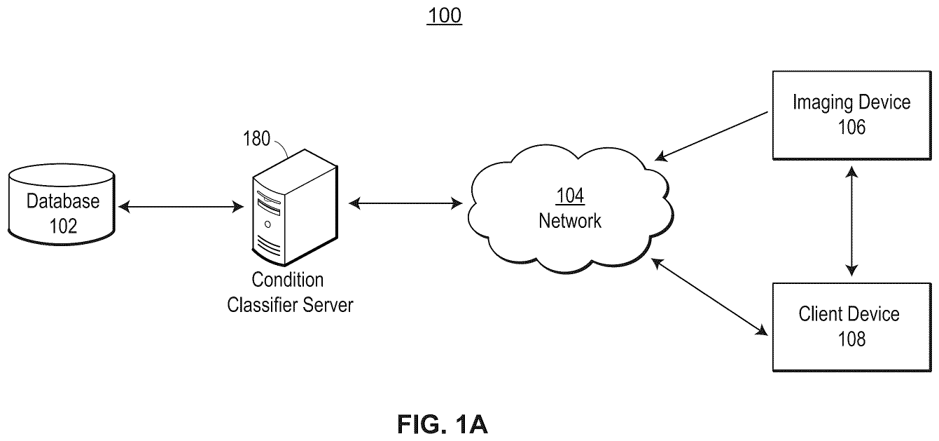

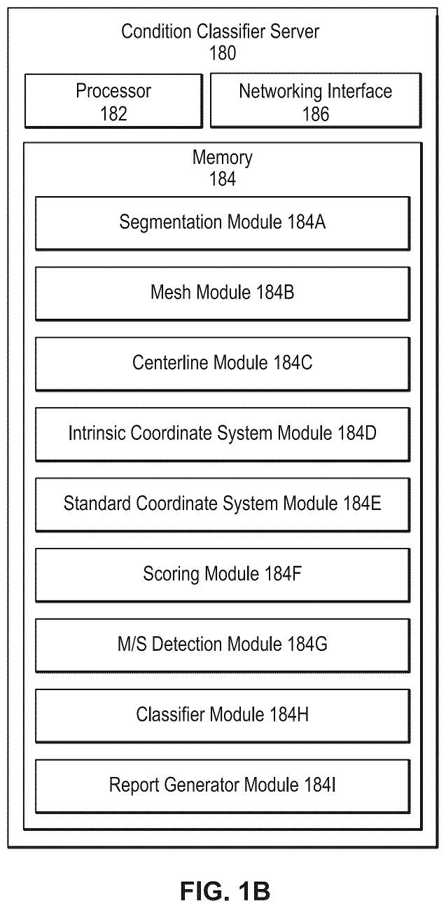

Referring to FIG. 1A, an example aortic condition classifier system 100 includes a condition classifier server 180, an imaging device 106, and a client device 108. The imaging device 106 and the client device 108 may be communicatively connected to each other. The condition classifier server 180 may be communicatively connected to the imaging device 106 and the client device 108 through a network 104. In an embodiment, the condition classifier server 180 may communicate via wireless signals over the network 104 with the imaging device 106 and the client device 108, which can be any suitable local or wide area network(s) including a Wi-Fi network, a Bluetooth network, a cellular network such as 3G, 4G, Long-Term Evolution (LTE), 5G, the Internet, etc. In some instances, the imaging device 106 and the client device 108 may communicate with the digital network 104 via an intervening wireless or wired device, which may be a wireless router, a wireless repeater, a base transceiver station of a mobile telephony provider, etc.

The client device 108 may include, by way of example, a tablet computer, a network-enabled cell phone, a personal digital assistant (PDA), a mobile device smart-phone also referred to herein as a “mobile device,” a laptop computer, a desktop computer, a portable media player (not shown), a wearable computing device such as Google Glass™ (not shown), a smart watch, a phablet, any device configured for wired or wireless RF (Radio Frequency) communication, etc.

The imaging device 106 may include, by way of example, a computed tomography (CT) imaging device, a magnetic resonance imaging (MRI) device, an ultrasound imaging device, a positron emission tomography (PET) imaging device, a single-photon emission computed tomography (SPECT) device, an X-ray fluoroscopy device, or any other suitable imaging system. Additionally, the imaging device may comprise hybrid imaging systems, such as PET-CT, PET-MRI, or SPECT-CT, to provide comprehensive diagnostic information. In various examples herein, the captured aortic image data is CT image data.

The client device 108 may interact with the imaging device 106 to transmit an aortic image data and receive an aortic condition of the aortic image data. In some embodiments, the imaging device 106 may transmit the aortic image data directly. The client devices 108 can enable users to access the condition classifier server 180 from different environments and contexts. Upon receiving the aortic image data, the condition classifier server 180 can process the input (e.g., the aortic image data) to determine a similarity score, a mid-ascending to sinus (M/S) ratio score, and an aortic size index (ASI) score. The condition classifier server 180 then can use the similarity score, the M/S ratio score, and/or the ASI score to determine an aortic condition of the aortic image data. The condition classifier server 180 can then transmit the aortic condition back to the client device 108.

The condition classifier server 180 may be communicatively coupled to a database 102. The database 102 may store information associated with patients associated with the condition classifier server 180 including historical aortic image data, classifications of healthy aortic images, classifications of pathological aortic images, mesh structures of aortic image data including healthy aortic mesh structures and pathological aortic mesh structures, different similarity scores of the mesh structures, M/S ratio scores of the mesh structures, ASI scores of the mesh structures, etc. The database 110 may also store training data that the condition classifier server 202 can use to train its segmentation model, diameter measuring model, and reference shape model.

The segmentation model, diameter measuring model, and the reference shape model may be configured to implement machine learning, such that the model/engine “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one machine learning method and algorithm may be applied, which may include but is not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of several categorizations of machine learning, such as supervised learning, unsupervised learning, and reinforcement learning.

In one embodiment, the segmentation model, the diameter measuring model, and the reference shape model may employ supervised learning, which involves identifying patterns in existing data to make predictions about subsequently received data. Specifically, the segmentation model, the diameter measuring model, and the reference shape model may be “trained” using training data, which includes example inputs and associated example outputs. Based upon the training data, the segmentation model, the diameter measuring model, and the reference shape model may generate a predictive function which maps outputs to inputs and may utilize the predictive function to generate machine learning outputs based upon data inputs.

In another embodiment, the segmentation model, the diameter measuring model, and the reference shape model may employ unsupervised learning, which involves finding meaningful relationships in unorganized data. Unlike supervised learning, unsupervised learning does not involve user-initiated training based upon example inputs with associated outputs. Rather, in unsupervised learning, the segmentation model, the diameter measuring model, and the reference shape model may organize unlabeled data according to a relationship determined by at least one machine learning method/algorithm employed by the similarity score model and M/S ratio model. Unorganized data may include any combination of data inputs and/or machine learning outputs as described above.

In yet another embodiment, the segmentation model, the diameter measuring model, and the reference shape model may employ reinforcement learning, which involves optimizing outputs based upon feedback from a reward signal. Specifically, the segmentation model, the diameter measuring model, and the reference shape model may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

After training, machine learning programs (or information generated by such machine learning programs) may be used to evaluate additional data. Such data may be and/or may be related to intent data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset.

It is to be understood that supervised machine learning and/or unsupervised machine learning may also comprise retraining, relearning, or otherwise updating models with new, or different, information, which may include information received, ingested, generated, or otherwise used over time.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

FIG. 1B is an expanded block diagram of an example condition classifier server 180, in accordance with various aspects of the present disclosure. Generally speaking, the condition classifier server 180 receives an aorta image data of a patient, generates a mesh structure of the aorta image data, determines an intrinsic coordinate system for the mesh structure, maps the mesh structure to a reference coordinate system, embeds a plurality of mapped vertices into the mesh structure, compares the embedded mesh structure to a normal aortic mesh structure and a pathological aortic mesh structure to determine a similarity score (statistical shape model (SSM) score), and classifies an aortic condition of the patient.

The condition classifier server 180 includes one or more processors 182, one or more memories 184, and a networking interface 186. The memories 184 include segmentation module 184A, a mesh module 184B, a centerline module 184C, an intrinsic coordinate system module 184D, a standard coordinate system module 184E, a scoring module 184F, mid-ascending to sinus (M/S) detection module 184G, a classifier module 184H, and a report generator module 184I. In some embodiments, the condition classifier server 180 may be the condition classifier server 180 of FIG. 1A.

The condition classifier server 180 may receive an aorta image data of a patient through the networking interface 186. The condition classifier server 180 may use a segmentation module 184A to segment the aorta image data. The segmentation module 184A may comprise a segmentation model, which may be a machine learning model trained on labeled data to accurately identify and delineate the boundaries of the aorta within the image. The segmentation module 184A may isolate the aorta in the aorta image data from surrounding tissues that enables precise shape analysis. In some embodiments, the segmentation model may generate a probability map indicating the likelihood that a given area in the image corresponds to the aorta. The segmentation module may then binarize this probability map, assigning a value of 1 to areas with a probability of 0.5 or higher, and 0 to areas with a probability below 0.5.

The condition classifier server 180 may then use a mesh module 184B to generate a mesh structure of an aorta of a patient using the segmented aorta image data. The mesh module 184B may use a mesh generator to generate the mesh structure. The mesh generator may convert the segmented aorta into a 3D geometric representation by creating a network of interconnected vertices, edges, and faces. Each vertex in the mesh represents a point on the surface of the aorta, with edges connecting the vertices to form basic geometric elements, such as triangles or quadrilaterals, that make up the mesh. These faces collectively approximate the continuous surface of the aorta, allowing for detailed shape analysis. The mesh generator may be tuned and adjusted to balance the trade-off between computational efficiency and the precision of the representation by adjusting the density of the mesh vertices. The mesh structure can provide a mathematical model of the aorta, facilitating subsequent analysis such as shape comparison and condition classification, which will be further explained in later modules.

Upon generating the mesh structure, the mesh module 184B may smooth the mesh of the mesh structure. The mesh module 184B may use a surface smoothing algorithm (e.g., Taubin's algorithm) to remove high curvature variations that could distort the analysis. The surface smoothing algorithm may use a linear low-pass filter to remove the high curvature variations without producing shrinkage to the mesh structure, ensuring that the mesh structure accurately reflects the original geometry of the aorta.

The mesh module 184B may then apply a down-sampling algorithm to the smoothed mesh structure to reduce the number of vertices while maintaining a representative surface. The down-sampling algorithm evaluates each vertex by assigning it to a priority queue based on the introduced error of its removal. The introduced error measures how much the mesh's surface will deviate from its original shape if that vertex is deleted. Vertices with the least impact on the overall mesh accuracy are prioritized for removal. As vertices are removed, the mesh structure is re-triangulated to ensure the remaining vertices accurately represent the original surface. This iterative process continues until a down-sampled mesh structure is produced, balancing simplicity with surface fidelity. The down-sampled mesh structure may provide faster processing of the mesh structure for analysis.

In some embodiments, the mesh module 184B may remove certain vertices that are unwanted from the mesh structure. For example, the mesh module 184B may remove the arch vessels and any part of the aorta beyond the celiac from the mesh structure. This may ensure that the mesh structure contains the same region of the aorta for different aortic image data.

The condition classifier server 180 may then use a centerline module 184C on the mesh structure to identify a centerline of the mesh structure. The centerline may be a path that runs through the central part of a vessel (e.g., aorta) and may be calculated as the shortest paths between two extremal points. The centerline module 184C may implement a centerline algorithm to determine the centerline between the two extremal points.

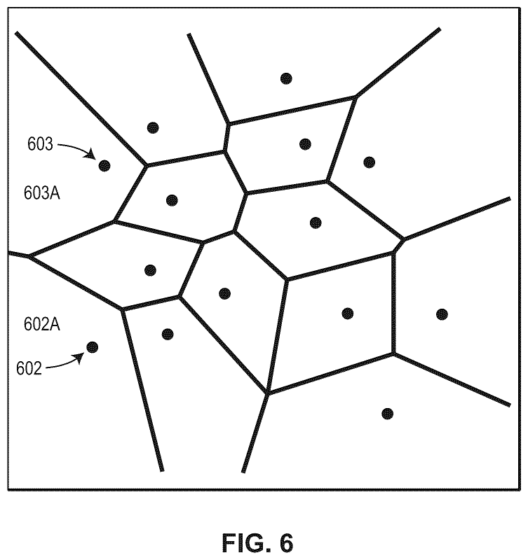

The centerline algorithm may use a Voronoi diagram, which partitions space into regions based on proximity (distance) to a set of vertices. Each region contains an area closer to one particular vertex than to any other. For example, in FIG. 6, the vertex 602 may have a polygon region 602A and the vertex 603 may have a polygon region 603A using the Voronoi diagram. Since the mesh structure is three-dimensional, each vertex's region may be represented as a polyhedron.

The centerline algorithm may then determine a maximal inscribed sphere within each polyhedron derived from the Voronoi diagram. The radius of each sphere corresponds to the distance from its center to the nearest boundary of the polyhedron. Once the maximal inscribed spheres are computed for all polyhedrons, the centerline algorithm connects these spheres, considering their radii. In cases where gaps exist between spheres due to the geometry of the polyhedron, the algorithm assigns appropriate edge weights to ensure the spheres are connected and represented accurately. Finally, the centerline algorithm applies a shortest path method (e.g., wave propagation, Dijkstra's algorithm) to determine the centerline between the two extremal points, effectively identifying the shortest path through the vessel. This shortest path may be the centerline of the mesh structure.

The centerline module 184C may apply post-processing algorithms to refine the initially computed centerline, which may exhibit some jaggedness due to the discrete nature of the Voronoi diagram and mesh structure. To enhance the smoothness and accuracy of the centerline, the module may first resample the centerline using a spline filter, which interpolates the path to create a smoother, more continuous curve. For example, the centerline may consist of a series of straight segments connective vertices at irregular intervals. The spline filter uses these points to create a smooth continuous curve by interpolating additional points between them. Following resampling, the centerline module 184C may then apply a moving average filter to further smooth the path by averaging the positions of neighboring points along the centerline. For example, each point on the curve could be adjusted to the average position of itself and its two immediate neighbors. This combination of resampling and smoothing ensures that the final centerline is both smooth and accurately represents the central path of the vessel.

Upon smoothing and resampling the centerline, the centerline module 184C may project the centerline data to each vertex in the mesh structure. For example, information such as distance to the closest centerline point (r) for each vertex in the mesh structure may be inscribed for each vertex. Additionally, a longitudinal position of the closest centerline point (h) and angle with respect to the centerline's orientation vector (a) may be inscribed to each vertex in the mesh structure. The orientation vector of the centerline may be determined by finding the closest centerline point near the ascending aorta and an innominate bifurcation. The orientation vector at the centerline point may then be defined as the vector normal to the bifurcation plane. The orientation vector at all other centerline points may be found by translating the orientation vector to those points using a parallel transport theory. This information is used to construct an intrinsic coordinate system, which are later described in the intrinsic coordinate system module 184D.

The condition classifier server 180 may then use the intrinsic coordinate system module 184D to determine an intrinsic coordinate system for the mesh structure. The intrinsic coordinate system module may provide a standardized coordinate system in which all types of mesh structures can be accurately aligned and compared. This system ensures that variations in the mesh generation process, such as differences in vertex density or distribution, do not affect the consistency of analysis. By mapping the original mesh structure to this intrinsic coordinate system, the module allows for the uniform evaluation of geometric properties and other relevant metrics, enabling more reliable diagnostic and predictive modeling across different patient datasets.

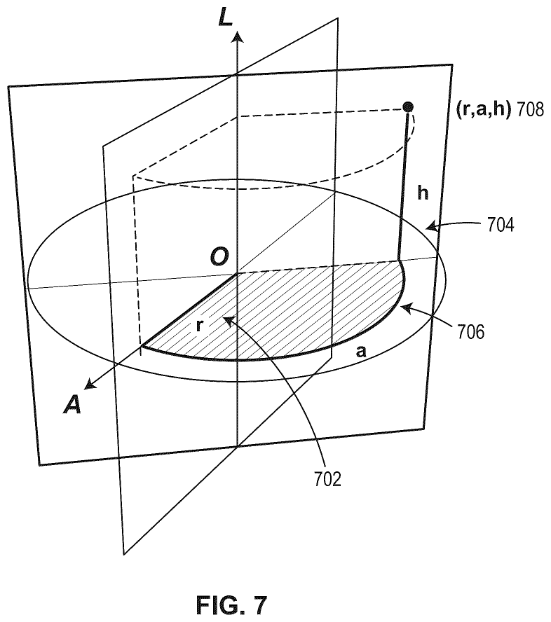

The intrinsic coordinate system may use the projected vertices of the mesh structure to convert the (x,y,z) coordinates of the vertices into the intrinsic coordinate of (r,a,h) coordinate where r is the distance to the closest centerline point, a is the angle with respect to the centerline's orientation vector, and h is the longitudinal position along closest centerline point. All this information may be already projected in each vertex from the centerline module 184C, and the intrinsic coordinate system module 184D converts each vertex the (x, y, z) coordinates into the (r, a, h). An example illustrating the intrinsic coordinate system may be shown in FIG. 7 where a measurement 702 indicates the radius (r), a measurement 704 indicates the longitudinal position along centerline (h), and a measurement 706 indicates the angle with respect to centerline orientation vector (a).

In order to standardize different mesh structures (as placement and distribution of vertices vary significantly), intrinsic coordinate system module 184D may use a cylindrical template to determine the intrinsic coordinate system for the mesh structure. For example, one mesh structure may have 10000 vertices for its shape while another mesh structure may have 5000 vertices for its shape, and therefore a standardization of these mesh structures may be needed. The cylindrical template may serve as a standardized grid, providing a consistent reference for mapping the vertices of the mesh structure. The cylindrical template may have evenly spaced vertices with different (a,h) values. For each vertex in the cylindrical template, the closest corresponding vertex in the original aortic mesh is identified. This is done using a “nearest neighbor” approach, where the vertex from the aorta's mesh that has the closest (a,h) values to the template vertex is selected. For example, if a template vertex has coordinates (al=0.1,h1=1.0), and the nearest vertex in the mesh structure has coordinates (a=0.11,h=1.02), then this vertex from the mesh structure is assigned to the corresponding position in the template. This assignment would be made for every vertex in the cylindrical template using the mesh structure. This new mesh based on the cylindrical template may be termed corresponding mesh structure. The corresponding mesh structure may ensure consistency across different datasets.

The condition classifier server 180 may use the standard coordinate system module 184E to map the corresponding mesh structure to a reference coordinate system. The reference coordinate system may be in Cartesian (x,y,z) coordinate similar to the original mesh structure, but now the coordinates will be standardized due to the corresponding mesh structure. For each vertex in the corresponding mesh structure, a reference coordinate system may be determined and may be embedded into the corresponding vertex. For example, the server may calculate the (x,y,z) coordinates by transforming the standardized intrinsic coordinates (r,a,h) from the intrinsic coordinate system into their corresponding Cartesian coordinates, and embed the (x,y,z) coordinate to the corresponding vertex in the corresponding mesh structure to thereby determine an embedded mesh structure.

The condition classifier server 180 may then use the scoring module 184F to calculate a similarity score between the embedded mesh structure and a set of reference mesh structures. This set includes both a normal aortic mesh reference structure and a pathologic aortic mesh reference structure. The scoring module 184F can obtain these reference structures through a reference shape model, which may be a machine learning model trained to generate reference mesh shapes. For example, the reference shape model may utilize training data comprising normal aortic mesh structures to develop the normal aortic mesh reference structure.

The scoring module 184F may then proceed to compare the embedded mesh structure to the normal aortic mesh reference structure and the pathologic aortic mesh reference structure to determine a similarity score. The scoring module 184F may employ a similarity algorithm (e.g., cosine similarity) to determine the similarity between the embedded mesh structure and the reference mesh structures. Each vertex in the embedded mesh structure may be compared with each vertex in the normal aortic mesh reference structure and the pathologic aortic mesh reference structure. For example, the embedded mesh structure may be depicted with a matrix of a number of vertex by dimensions. Assuming that there are 4200 vertices and (x,y,z) coordinates have 3 dimensions, the scoring module 184F may build a 4200 by 3 matrix for the embedded mesh structure. This matrix will then be used to compare with matrices of the reference mesh structures, which may also be a 4200 by 3 matrix. The matrix of the embedded mesh structure may then be compared with the matrices of the reference mesh structures (via cosine similarity) to determine a similarity score.

In some embodiments, the scoring module 184F may utilize a scoring model, which could be a machine learning model trained to generate the similarity score upon receiving the embedded mesh structure. This model may have been trained on a large dataset of annotated aortic meshes, including both normal and pathological cases. During training, the model learns to recognize patterns and subtle differences in mesh structures that correspond to various aortic conditions. The scoring model might incorporate features such as vertex position, curvature, and distance metrics to accurately assess similarity.

The scoring module 184F may scale the similarity score to be in a predefined range of number. For example, +1 may indicate that the embedded mesh structure perfectly matches the pathology aortic mesh structure while −1 may indicate that the embedded mesh structure perfectly matches the normal aortic mesh structure. A positive similarity score may indicate that that the embedded mesh structure is closer to the pathologic aortic mesh reference structure, indicating that the patient has the aortic condition. A negative similarity score may indicate that the embedded mesh structure is closer to the normal aortic mesh reference structure, indicating that the patient does not have the aortic condition.

The condition classifier server 180 may use the M/S detection module 184G to determine a M/S ratio score. The condition classifier server 180 may use a diameter measuring model to determine the diameter of the mid-ascending aorta and the diameter of the sinuses of the segmented aortic image data. The diameter measuring model can be trained using a dataset of annotated medical images, where the diameters of the mid-ascending aorta and the sinuses have been precisely measured and labeled by experts. This training allows the model to accurately identify and measure these critical dimensions in new, unseen aortic image data. The M/S detection module then calculates the M/S ratio score by dividing the measured diameter of the mid-ascending aorta by the diameter of the sinuses.

The condition classifier server 180 may use the classifier module 184H to determine the aortic condition of the patient based on the similarity score, the M/S ratio score, or the ASI score. The ASI score is a metric that normalizes the diameter of the aorta by accounting for the patient's body surface area. The classifier module 184H can make this determination by evaluating each score individually or by combining multiple scores to provide a more comprehensive assessment. The classification process may be carried out using a predefined algorithm designed to interpret these scores, or it may involve a machine learning model that has been trained to classify aortic conditions based on these inputs. The classifier module 184H is thus capable of accurately diagnosing the aortic condition by leveraging various diagnostic metrics.

The condition classifier server 180 may use the report generator module 184I to generate various types of reports based on one or more of the similarity score, M/S ratio score, or ASI score, or corresponding aorta classification. One type of report may highlight specific areas within the aortic image data suggesting the presence of an aortic condition. For example, one type of report might include a heat map that visually indicates regions of the aorta where bulging occurs, compared to a normal aorta, helping clinicians quickly identify areas of concern. Additionally, the report may provide quantitative metrics, annotated images, or 3D models that offer a comprehensive overview of the aortic condition, aiding in diagnosis, treatment planning, and patient communication.

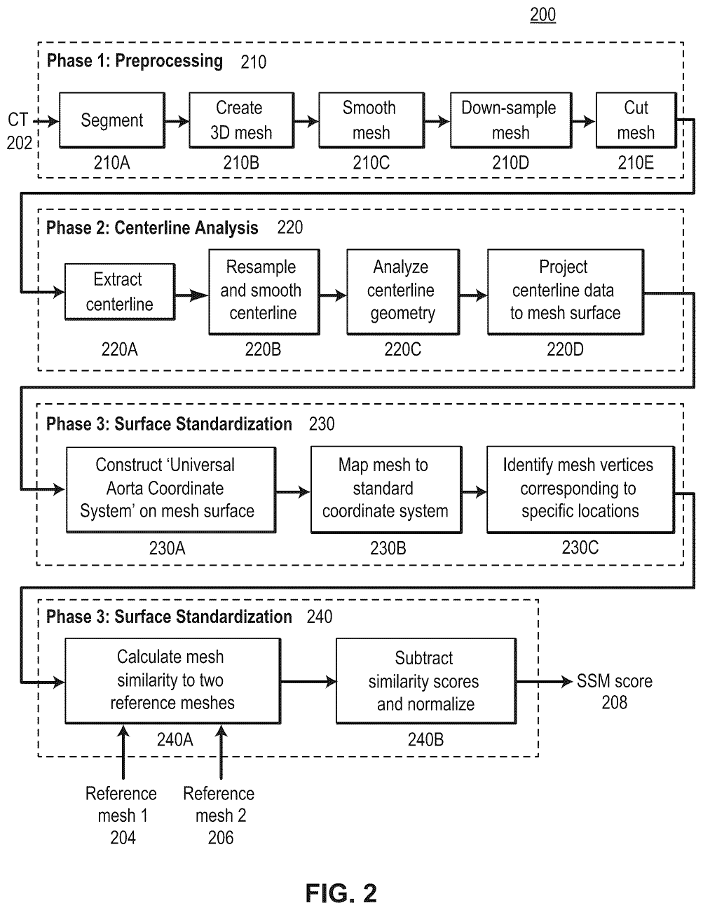

FIG. 2 depicts a flow diagram of a process 200 for determining a similarity score, in accordance with various aspects of the present disclosure. A condition classifier server may receive an aorta image data 202 (e.g., CT scan) from an imaging device. In the preprocessing blocks 210 (210A, 210B, 210C, 210D, 210E), the condition classifier server may convert the aorta image data into a mesh structure. In the centerline analysis blocks 220 (220A, 220B, 220C, 220D), the condition classifier sever may determine a centerline and project the data of the centerline into the mesh structure. In the surface standardization blocks 230 (230A, 230B, 230C), the condition classifier server may determine an intrinsic coordinate system for the mesh structure, map the mesh structure to a reference coordinate system, and embed a plurality of vertices to the reference coordinate system. In the surface standardization blocks 240 (240A, 240B), the condition classifier server may determine a similarity score using the mesh structure.

In block 210A, the condition classifier server may segment the aorta image data 202 using a segmentation model to determine a segmented aorta image data. In block 210B, the condition classifier server may use a mesh generator to determine a mesh structure using the segmented aorta image data. In block 210C, upon determining the mesh structure, the condition classifier server may apply a smoothing algorithm to the mesh structure to smooth the mesh of the mesh structure (e.g., removing high curvature variations that could distort the analysis). In block 210D, the condition classifier server may then apply a down-sampling algorithm to the smoothed mesh structure to reduce the number of vertices, retaining only the most relevant vertices in the smoothed mesh structure. In block 210E, the condition classifier server may cut or remove certain vertices that are unwanted from the mesh structure after the down-sampling. For example, the condition classifier server may remove parts of aorta that go beyond the thoracic aorta for analysis. In some embodiments, a user using a client device may cut or remove that parts of the mesh structure that are unwanted and transmit the updated mesh structure to the condition classifier server.

In block 220A, the condition classifier server may use a centerline algorithm to identify a centerline of the mesh structure. The centerline may be a path that runs through the central part of the aorta and may be calculated as the shortest paths between two extremal points. In block 220B, the condition classifier may apply post-processing algorithms to resample and smooth the centerline. In block 220C, upon applying the post-processing algorithms, the condition classifier server may analyze the centerline geometry and determine data of the mesh centerline for each vertex in the mesh structure including a distance to the closest centerline point (r), a longitudinal position of the closest centerline point (h), and an angle with respect to an orientation vector defined on the centerline (a). In block 220D, the condition classifier may project the data of the mesh centerline to each vertex in the mesh structure.

In block 230A, the condition classifier server may determine an intrinsic coordinate system for the mesh structure. The intrinsic coordinate system may provide a standardized coordinate system in which different types of mesh structures can be aligned and compared. The intrinsic coordinate system may convert the mesh structure coordinates (e.g., Cartesian coordinates) to the intrinsic coordinate (e.g., Cylindrical coordinates). The intrinsic coordinate system may comprise of (r,a,h) coordinates, where r is the distance closest to the centerline point, a is the angle with respect to the orientation vector of the closest centerline point, and h is the longitudinal position of the closest centerline point. Therefore, each vertex in the mesh structure may be converted from the mesh structure coordinates to the intrinsic coordinates. The condition classifier server may use a cylindrical template to determine the intrinsic coordinates for the mesh structure to determine a corresponding mesh structure.

In block 230B, the condition classifier server may map the corresponding mesh structure into a reference coordinate system (e.g., Cartesian coordinates). In block 230C, the condition classifier may embed the reference coordinates (x, y, z) to the corresponding vertex in the corresponding mesh structure to determine an embedded mesh structure.

In block 240A, the condition classifier server may determine a similarity score between the embedded mesh structure and a plurality of reference mesh structures comprising a normal aortic mesh structure and a pathology aortic mesh structure. The condition classifier server may compare the vertices of the embedded mesh structure to the vertices of the normal aortic mesh structure and the pathology aortic mesh structure using a similarity algorithm (e.g., cosine similarity) to determine an initial similarity score. In block 240B, the condition classifier server may scale the initial similarity score to be in a predefined range of number to determine the similarity score. For example, +1 may indicate that the embedded mesh structure perfectly matches the pathology aortic mesh structure while −1 may indicate that the embedded mesh structure perfectly matches the normal aortic mesh structure.

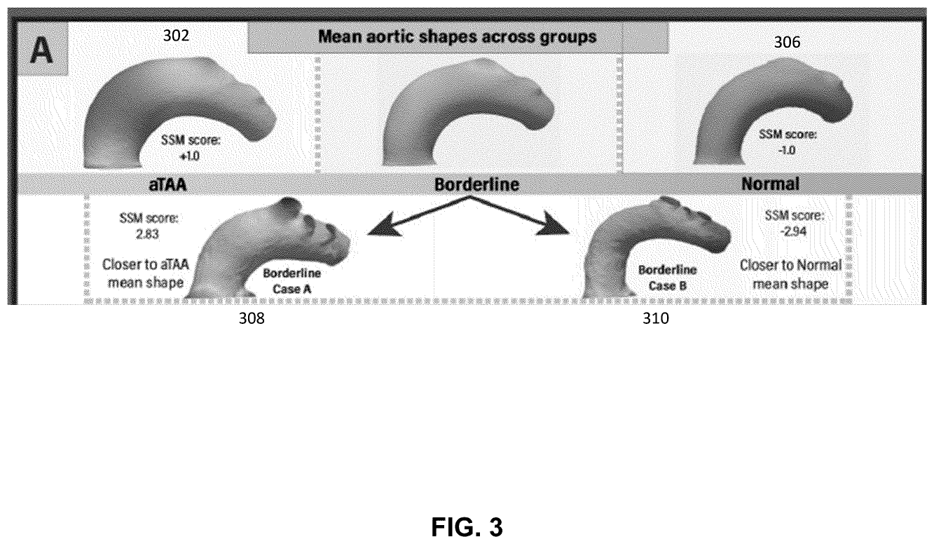

FIG. 3 depicts images of different aortic conditions with different similarity scores, along with reference aortic images. The aortic images may be displayed in different heatmaps, where the certain bulging of the aorta is colored with lighter color (e.g., red). The aortic image 302 may be a pathology aortic mesh structure with a similarity score of +1. The aortic image 306 may be a normal aortic mesh structure with a similarity score of −1. The aortic images 308 and 310 may be mesh structures of different patients. The aortic image 308 may have a similarity score of +2.83, which may strongly indicate that the patient has the aortic condition. The aortic image 308 may have a similarity score of −2.94, which may strongly indicate that the patient does not have the aortic condition.

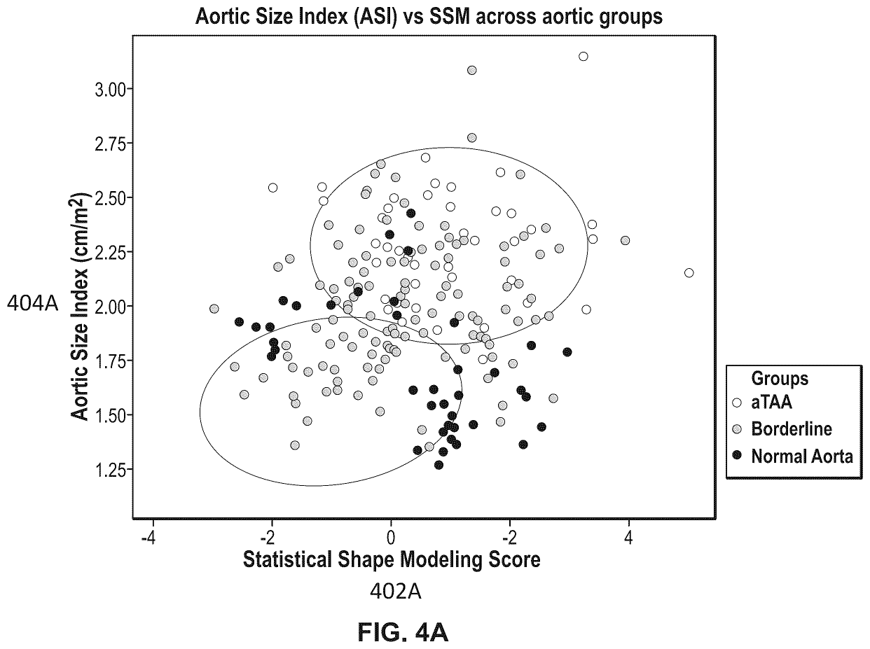

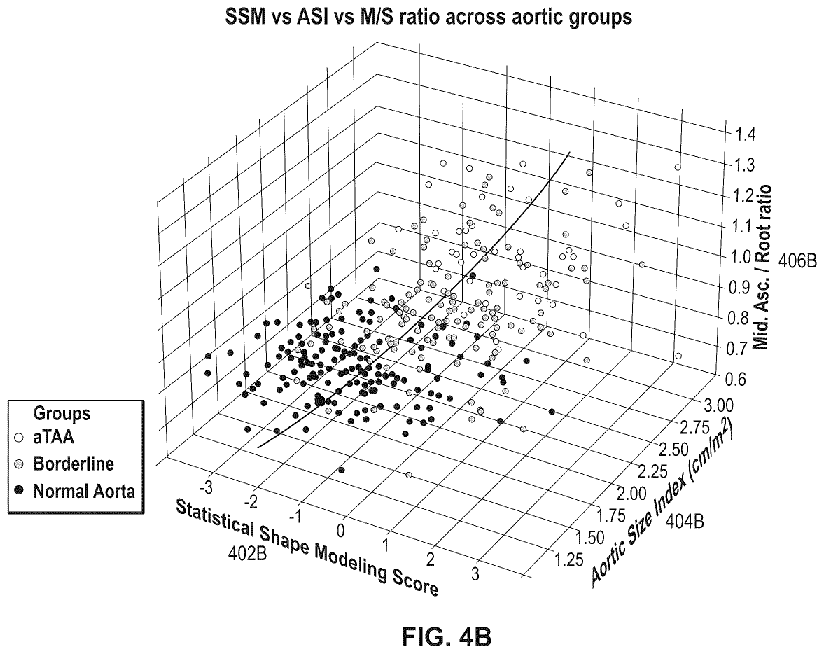

FIG. 4A shows a plot illustrating different aortic conditions based on an aortic size index (ASI) score 404A and a similarity score 402A. The plot indicates that low ASI scores and low similarity scores signify that a patient does not have an aortic condition while high ASI scores and high similarity scores signify that a patient does have an aortic condition. This correlation becomes more prevalent in FIG. 4B that shows a plot illustrating different aortic conditions based on an ASI score 404B, a similarity score 402B, and a M/S ratio score 406B. With the addition of the M/S ratio score 406B, the plot strongly indicates that with low ASI scores, low similarity scores, and low M/S ratio scores, a patient does not have an aortic condition while high ASI score, high similarity scores, and high M/S ratio scores strongly signify that a patient does have an aortic condition.

The plots of FIGS. 4A and 4B are from empirical examples implementing the present techniques, as now described. Aortic images of 334 adults without prior aortic repair, categorized into 3 groups: ascending thoracic aortic aneurysm (aTAA), Normal aorta controls, and a “Borderline” dilation may be obtained. The aTAA group (n=42) showed an average mid ascending diameter of 47±2 mm, and predominant mid-ascending dilation (M/S ratio=1.13±0.13). The normal aorta group (n=165) demonstrated a lower hypertension rate (14%; p<0.001), smaller mid-ascending diameter (29±3 mm), lower M/S ratio (0.87±0.08; p<0.001), and younger age (48±14 years; p<0.001). The remaining 127 patients were in the Borderline category. Combined SSM scores and ASI showed that 54% of borderline cases were closer to aTAA, while 34% were closer to normal aortas.

Adding the M/S ratio to a 3D plot revealed a discernible upward and rightward trend with increasing SSM score, ASI, and M/S ratio across disease severity strata. As shown, based on the plots, differences in 3D shapes and size ratios between normal ascending aortas and aTAA from CTAs can be exploited to quantify anatomic abnormalities in patients with borderline degrees of dilation. A novel combined shape-size assessment shows promise in adjudicating the severity of ascending aortic disease, especially in borderline cases, which could advance patient-specific management.

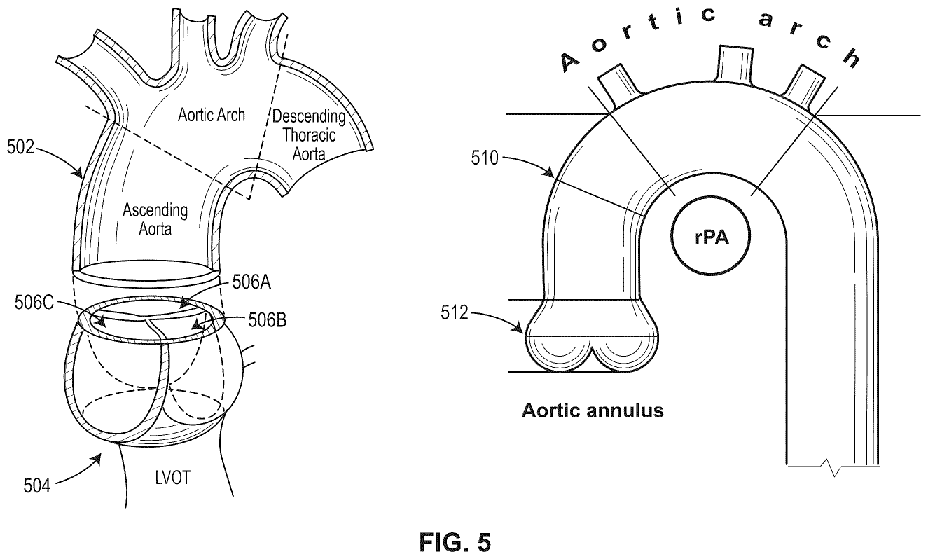

FIG. 5 depicts images of a thoracic aorta comprising ascending aorta 502 and an aortic root 504. The aortic root 504 may comprise three aortic sinuses, which are indicated by 506A, 506B, and 506C. A measurement 510 may indicate a diameter of the ascending aorta while a measurement 512 may indicate a diameter of the aortic sinuses 504.

FIG. 6 illustrates a Voronoi diagram which partitions space into regions based on proximity (distance) to a set of vertices. The vertex 603 may have a region 603A and the vertex 602 may have a region 602A. Each region in the diagram represents all points that are closer to its associated vertex than to any other vertex. This partitioning enables the analysis of spatial relationships and can be utilized in various applications such as mesh generation, resource allocation, and spatial data analysis. The boundaries between regions may be equidistant from the nearest pair of vertices, creating a comprehensive map of influence for each vertex in the diagram.

FIG. 7 illustrates an intrinsic coordinate system of an aorta. The intrinsic coordinate system may comprise an intrinsic coordinate (r,a,h) 708, where r is a measurement 702 indicating the radius or distance from the centerline (r), a is a measurement 706 indicating the angle with respect to the centerline's orientation vector (a), and h is a measurement 704 indicating the longitudinal position along centerline (h).

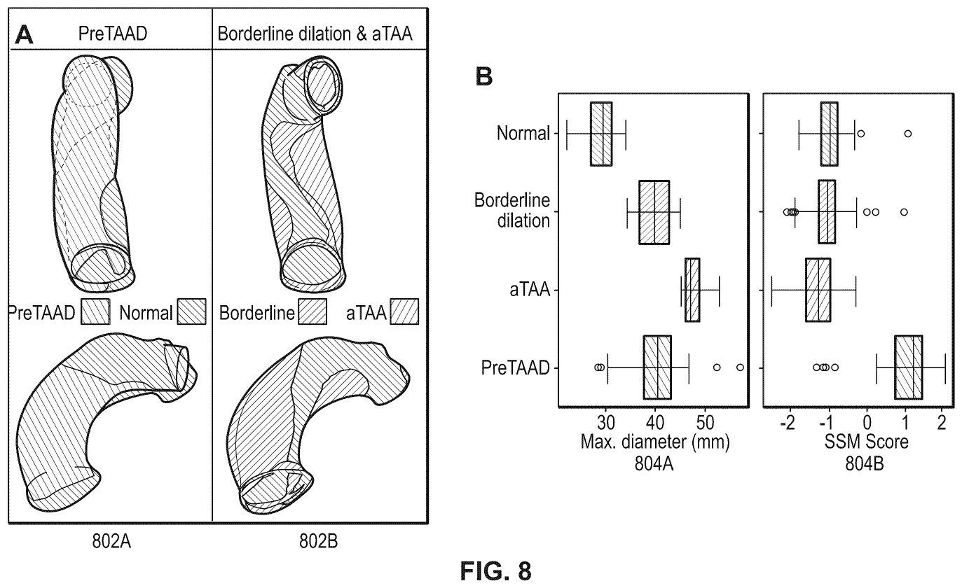

FIG. 8 demonstrates mean aortic shapes for different groups of patients (pre thoracic aortic aneurysm and dissection (pre-TAAD), normal, borderline, and aTTA) and box plots of the max diameter and SSM score stratified by the different groups, in accordance with various aspects of the present disclosure, in accordance with another empirical example.

Among the patients, the condition classifier may analyze 30 spontaneous TAAD patients with CTs at a median of 1.5 (IQR: 0.7-3.8) years pre-dissection. The condition classifier then compared the 30 TAAD patients against pre-existing cohorts with normal aortas (n=165), borderline dilation (n=119), and aTAA aneurysm (n=42). Age, sex and hypertension did not significantly differ between TAAD and aTAA groups.

The mean aortic shapes 802A of the different patients may comprise a mean pre-TAAD aortic shape superimposed over a mean normal aortic shape. The mean aortic shapes 802B may comprise a mean borderline aortic shape (e.g., borderline aortic condition) and a mean aTTA aortic shape superimposed over the mean normal aortic shape.

In box plot 804A, the maximum diameters of aortas were stratified among patients with normal, borderline, aTTA, and pre-TAAD aortic conditions. In box plot 804B, the similarity scores (e.g., SSM scores) of the aortas were similarly stratified among these groups. While the maximum diameter for aTTA is higher than that for pre-TAAD, the SSM score for pre-TAAD is clearly and distinctly higher than for aTTA. This indicates that the similarity score can be used to detect the pre-TAAD condition in a patient.

The SSM score for identifying the pre-TAAD condition is also significantly higher than that for other conditions, including normal aortic condition and borderline dilation. Interestingly, the normal, borderline, and aTTA conditions may all exhibit similar SSM scores when classifying TAAD. This suggests that TAAD may occur even when the aorta is deemed normal or borderline, not just in cases of aTTA. Therefore, the SSM score is effective in identifying the pre-TAAD condition regardless of the patient's current aortic condition.

Other observations may be observed from the patients. Max diameter (47.7±2.0 vs. 40.6±6.0 mm, p<0.01), centerline length (130±11.5 vs. 120±16.7 mm, p<0.01) and tortuosity (1.33±0.08 vs. 1.27±0.07, p<0.01) were higher in aTAA versus TAAD. Median SSM scores were higher in the (TAAD group 1.25, IQR: 0.76-1.46) compared to the aTAA group (−1.25, IQR: −1.60, −0.95; p<0.01) and the borderline dilation group (−1.03, IQR: −1.25, −0.84; p<0.01) FIG. 8. SSM scores for normal, borderline dilated and aTAA did not significantly differ.

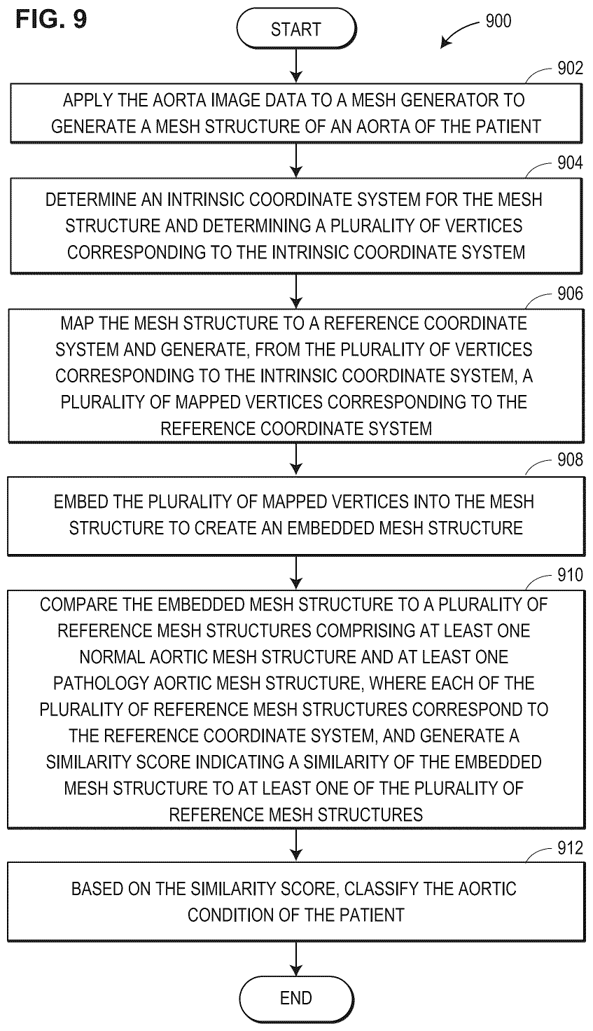

FIG. 9 depicts a flow diagram of an example method for classifying an aortic condition, in accordance with various aspects of the present disclosure. In some embodiments, the example method 900 may be implemented, wholly or partially, by any of the condition classifier server 180, the client device 108, and/or the imaging device 106.

The method classifies an aortic condition of a patient using a similarity score (e.g., shape-specific scoring (SSM)) derived from aorta image data. The image data is converted into a mesh structure, which is standardized by mapping it into a cylindrical space using an intrinsic coordinate system (e.g., Universal Coordinate System). This standardization aligns the aorta with a reference coordinate system (e.g., standardized coordinate system), enabling direct vertex-to-vertex correspondence between the patient's aorta and the reference mesh structures. The reference set may include both a normal and a pathological aortic mesh structure. The similarity score is then calculated based on the degree of correspondence, allowing for the classification of the aortic condition as normal or pathogenic.

In various examples, the shape-specific scoring (SSM score) provides a size-agnostic yet shape-dependent description of the aorta or its portions. This shape-based analysis can be combined with an analysis of size-dependent regions of the aorta (e.g., the aortic root) for a more comprehensive assessment and classification. For instance, the M/S ratio score and ASI score may be used alongside the similarity score to determine the overall aortic condition.

The method 900 includes applying the aorta image data to a mesh generator to generate a mesh structure of an aorta of the patient (block 902). The method 900 further includes determining an intrinsic coordinate system for the mesh structure and determining a plurality of vertices corresponding to the intrinsic coordinate system (block 904). The method 900 further includes mapping the mesh structure to a reference coordinate system and generating, from the plurality of vertices corresponding to the intrinsic coordinate system, a plurality of mapped vertices corresponding to the reference coordinate system (block 906).

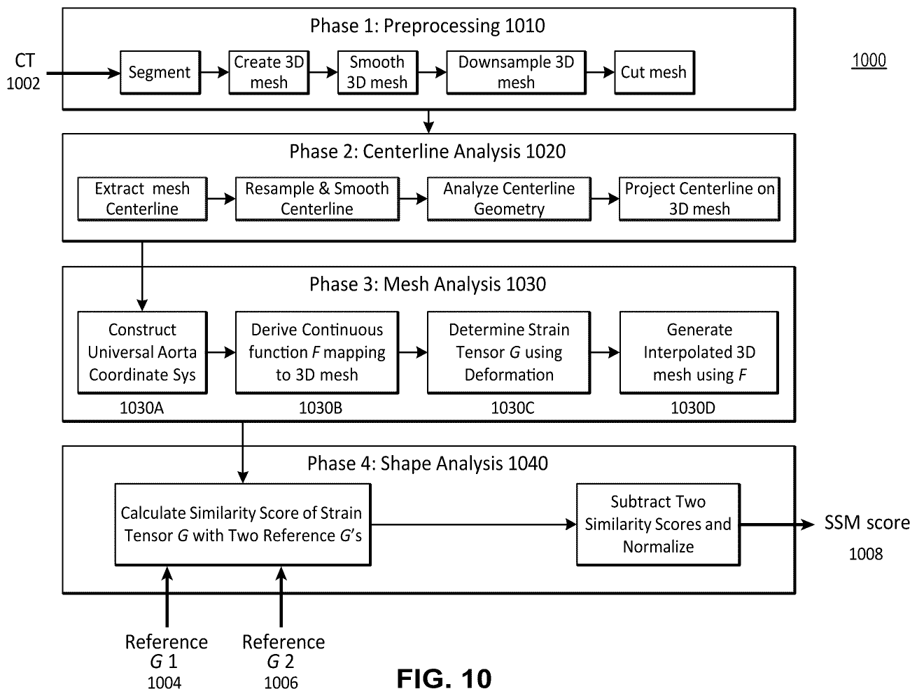

The method 900 further includes embedding the plurality of mapped vertices into the mesh structure to create an embedded mesh structure (block 908). The method 900 further includes comparing the embedded mesh structure to a plurality of reference mesh structures comprising at least one normal aortic mesh structure and at least one pathology aortic mesh structure, where each of the plurality of reference mesh structures correspond to the reference coordinate system, and generating a similarity score indicating a similarity of the embedded mesh structure to at least one of the plurality of reference mesh structures (block 910). In other example implementations, such as those corresponding to the example of FIG. 10, the processes of block 910 may be performed using reference strain tenors, instead of reference mesh structures. The method 900 further includes classifying the aortic condition of the patient based on the similarity score (block 912).

FIG. 10 illustrates a flow diagram of another example process 1000 for determining a similarity score, in a different manner than the process 200 of FIG. 2. The process 1000 includes a pre-processing sub-process, block 1010, similar to that of pre-process block 210 of FIG. 2. For example, at the block 1010, one or more of the following processes (not shown) may be implemented: (i) a segmentation of received CT image data 1002 is performed, for example, using U-Net; (ii) the segmentation is converted to a 3D mesh using a vascular model marching cubes or other techniques herein; (iii) a smoothing process is applied to the 3D mesh using a vascular surface smoothing or other techniques; (iv) the 3D mesh is downsampled using a vascular surface decimation or other techniques; and (v) remove portions of mesh outside region of interest, for example, using vascular surface clipper or other techniques. The techniques of block 1010 may be implemented using toolkits, such as those available from the Vascular Modeling Toolkit (VMTK) at www.vmtk.org.

At a block 1020, a centerline analysis is performed, by for example, (i) extracting mesh centerline using vascular model centerlines or another technique, (ii) resampling and smoothing centerline using vascular model centerline resampling and smoothing or another technique, (iii) Analyze centerline branches and geometry using several vascular model functions or another technique, and (iv) projecting centerline analysis results on to 3D mesh surface using vascular model surface projection or another technique. As with the block 1010, the techniques of block 1020 may be implemented using toolkits, such as those available from VMTK, mentioned above.

Where the process 1000 differs from that of the process 200, at least in large part, is the mesh analysis of block 1030 and the shape analysis of block 1040. That is, the processes of phases 1 and 2 are similar in processes 1000 and 200, with phase 1 in both preparing (aortic) meshes for analysis and phase 2 analyzing the aorta's centerline geometry in preparation to derive a universal aortic coordinate system. The process of block 1030, by contrast determines and uses a universal coordinate system to quantify the shape of the region of interest (e.g., the aorta) in a translation and a rotation invariant manner.

In the illustrated example, the phase 3 mesh analysis of the block 1030 is performed through sub-processes, as follows. At a block 1030A, the process 1000 constructs a universal aorta coordinate system, where each 3D mesh vertex is assigned a radius value, r, angle value theta, and height value, h, using the centerline analysis projection from the phase 2 process of block 1020. The values r, theta, and h may be normalized to the [−1, 1] interval. At a block 1030B, the process 1000 derives a continuous and differentiable function, F, that maps the 3D mesh's (theta, h) coordinates to its (x, y, z) coordinates. In an example, Chebychev polynomials are used for F, but other polynomials or function types may be used. For example, F may be derived as the degree d Chebychev polynomial that is the least squares fit to the (theta, h) to (x, y, z) mapping, where d is user-specified value used for all aortas in the analysis. At a block 1030c, the process 1000 computes a strain tensor, G, for example, a Right Cauchy-Green Strain Tensor, G, using the deformation tensor found by taking partial derivatives of F with respect to x, y, and z. From there, at the block 1040D, the process 1000 creates an “interpolated” 3D aortic mesh using F and a prescribed set of (theta, h) coordinates for the interpolated mesh vertices. The same set of coordinates (theta, h) are used for all aortic meshes in the analysis. G's value is computed for each vertex in the interpolated mesh. Further, at the block 1030D, a validation may be performed and the interpolated 3D aortic mesh saved and provided to the phase 4 shape analysis process of block 1040.

At the block 1040, the process 1000 analyzes the aortic shapes, for example, by classifying the shapes of new aortas using the mean shapes of cohorts of aortas. In the illustrated example, at block 1040A, the process 1000 calculates a similarity score of the aorta's strain tensor from the block 1030, e.g., the Right Cauchy Green Tensor G, with two reference G's. These reference G's could, for example, be the mean G for a set of ‘healthy’ aortas and mean G for a set of ‘pathological’ aortas, each shown respectively as 1004 and 1006. In an example, the block 1040A uses cosine similarity as the similarity measure, although other techniques for similar scoring may be used. At a block 1040B, the process 1000 subtracts the difference of the two similarity scores and rescales the value to be −1 if the aortic surface perfectly matches one mean shape and to +1 if it matches another mean shape. The result is the SSM score 1008. From the SSM score 1008, the aortic condition of the patient may thus be classified, e.g., using a process of block 912 in FIG. 9.

The process 1000 was configured, in some examples, to use the Right Cauchy Green Tensor G to describe the aortic shape in a rotation and translation invariant manner. The Reference G's can be calculated using the output of the processes of phase 3 1030. For example, the process 1000 could group aortic meshes into cohorts for which to compare, for instance, into “healthy” and “pathological” groups or “Male” and “Female” groups and then calculate the mean G for both cohorts and use those as the reference G's.

The phase 4 process of block 1040 can be modified in various ways. For example, the techniques can replace cosine similarity analysis with a machine learning (ML) model that is trained to classify a new aorta into a cohort (e.g., classify as “healthy” or “perturbed”). The techniques could replace the quantity for which the techniques are computing the similarity. For example, instead of performing similarities based on the aorta's x, y, z coordinates, other mesh properties could be used for similarity analysis, such as the radius or the curvature of locations in aorta. In yet other example, the techniques could take a principal component analysis (PCA) approach and calculate z-scores of new patient aortas with respect to different cohorts of aortas (e.g., with respect to healthy aortas and/or with respect to pathological aortas). In other words, once we extract aortic shape in phases 1 to phase 3, many different techniques may be used avenues for analysis that would be useful in a clinical setting.

It should be understood that not all blocks and/or events of the exemplary diagrams and/or flowcharts are required to be performed. Moreover, the exemplary diagrams and/or flowcharts are not mutually exclusive (e.g., block(s)/events from each example diagram and/or flowchart may be performed in any other diagram and/or flowchart). The exemplary diagrams and/or flowcharts may include additional, less, or alternate functionality, including that discussed elsewhere herein.

In sum, it will be appreciated to those skilled in the art, ascending aortic aneurysms of disease is largely characterized by maximal aortic size, measured as a one-dimensional diameter taken from a plane that is orthogonal to the aortic centerline. Maximal diameter measurements or change in such measurements over time (i.e., growth) form the basis of surveillance and surgical treatment recommendations in current clinical guidelines. However, the diameter has a number of well-recognized limitations in characterizing ascending aortic aneurysm pathology. Specifically, the aorta is an obviously complex three-dimensional structure, and shape features which define the three-dimensional pattern of dilation (e.g., location of maximal dilation, diffuseness, eccentricity) cannot be represented by a single maximal diameter measurement, the metric which is being used to guide current patient care. Additionally, there are several procedural factors related to how the measurements are performed—often manually but increasingly using automated techniques—that can significantly impact the magnitude of the measured aortic diameter, including variability in measurement plane/location and decisions regarding inclusion versus exclusion of the aortic wall. These sources of variability have been shown to not infrequently result in discrepancies in maximal diameter measurement by up to 5 mm, a magnitude which could significantly change patients risk estimates and candidacy for surgical repair.

One of the greatest limitations of aortic diameter measurements is that this metric performs poorly at predicting the risk of developing type A aortic dissection (TAAD), a rare but potentially life-threatening complication of aTAA. A number of studies have shown that maximal aortic diameter measurement prior to TAAD onset is far below surgical thresholds (average pre-dissection diameter in the 40-45 mm range), with less than 20% of aTAA patients meeting criteria for surgical repair prior to dissection (i.e., aortic size paradox). This aortic size paradox represents one of the most important challenges aTAA given the difficulty identifying individuals with severe disease at pre-surgical sizes, among a dramatically larger population of individuals with indolent mild aortic dilation, which are at least 100 time more common.

A significant number of studies have examined the value of adjusting the absolute maximal aortic diameter by a metric of body size (e.g., height weight), to create a better numeric representation of the relative aortic size compared to the patient's overall body size. However, to date, these body size adjustments have shown only minimal improvements in the ability to discriminate individuals within the overall population that are at highest risk for TAAD. Further, several prior studies have looked beyond the aortic diameter at the length of the ascending aorta as a metric of risk based on the concept that stresses in the axial/longitudinal direction have been hypothesized to play a role in dissection initiation. A smaller number of studies have investigated the role of three-dimensional thoracic aortic shape using statistical shape modeling (SSM) technique, work which has mostly focused on identification of unique shapes and modes of shape variation that align with specific aneurysm etiology (e.g., bicuspid aortic valve related aeropathy, heritable/genetic thoracic aortic disease). To date, these studies have not revealed any quantitative metrics that relate to the risk of TAAD development or development of other clinically relevant adverse events.

Among the advantages discussed herein, the present techniques provide new methods to identify and quantify unique shape metrics that are associated with the risk of TAAD using both standard size metrics (e.g., diameter) and novel 3-dimensional shape features. We describe methods that involve the creation of a universal aortic coordinate system to allow statistical comparison of individuals across populations and sub-groups with subsequent quantification of metrics that represent the degree of similarity between an individual's three-dimensional aortic anatomy compared against a reference population(s). The objective is to create a size-agnostic metric of abnormal aortic shape that can be used to infer risk of aortic complications.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as an example only and does not describe every possible embodiment, as describing every possible embodiment would be impractical, if not impossible. One could implement numerous alternate embodiments, using either current technology or technology developed after the filing date of this application.

What is claimed:

1. A method for classifying an aortic condition of a patient from aorta image data of a patient, the method comprising:
applying, by one or more processors, the aorta image data to a mesh generator to generate a mesh structure of an aorta of the patient;
determining, by the one or more processors, an intrinsic coordinate system for the mesh structure and determining a plurality of vertices corresponding to the intrinsic coordinate system;
mapping, by the one or more processors, the mesh structure to a reference coordinate system and generating, from the plurality of vertices corresponding to the intrinsic coordinate system, a plurality of mapped vertices corresponding to the reference coordinate system;
embedding, by the one or more processors, the plurality of mapped vertices into the mesh structure to create an embedded mesh structure;
comparing, by the one or more processors, the embedded mesh structure to a plurality of reference mesh structures comprising at least one normal aortic mesh structure and at least one pathology aortic mesh structure, where each of the plurality of reference mesh structures correspond to the reference coordinate system, and generating a similarity score indicating a similarity of the embedded mesh structure to at least one of the plurality of reference mesh structures; and
based on the similarity score, classifying, by the one or more processors, the aortic condition of the patient.

2. The method of claim 1, wherein determining the mesh structure further includes:
segmenting, by the one or more processors, the aorta image data of a patient using a segmentation model to determine a segmented aorta image data; and
applying, by the one or more processors, the segmented aorta image data into the mesh generator to determine the mesh structure.

3. The method of claim 1, wherein generating the mesh structure further comprises:
applying, by the one or more processors, a surface smoothing algorithm to the mesh structure; and
applying, by the one or more processors, a down-sampling algorithm to the mesh structure.

4. The method of claim 1, further comprising:
applying, by the one or more processors, a centerline algorithm to the mesh structure to determine an initial mesh centerline;
implementing, by the one or more processors, post-processing algorithms to the initial mesh centerline to determine a mesh centerline; and
projecting, by the one or more processors, data of the mesh centerline into the mesh structure.

5. The method of claim 4, wherein the applying the centerline algorithm to the mesh structure to determine the initial mesh centerline further comprises:
determining, by the one or more processors, a Voronoi diagram of the mesh structure;
calculating, by the one or more processors, a maximum inscribed sphere for each polyhedron of the Voronoi diagram;
connecting, by the one or more processors, radii of the maximum inscribed spheres; and
identifying, by the one or more processors, the initial mesh centerline by using a shortest path algorithm to identify a shortest path through the radii of the maximum inscribed spheres from one extremal point to another extremal point.

6. The method of claim 1, wherein the intrinsic coordinate system comprises of a distance to a closest centerline point (r), an angle normal to the closest centerline point (a), and a longitudinal position along the closest centerline point (h).

7. The method of claim 1, wherein the reference coordinate system is a Cartesian coordinate system.

8. The method of claim 1, further comprising:
determining, by the one or more processors, a first ratio score using the aorta image data of the patient.

9. The method of claim 8, wherein determining the first ratio score further comprises:
determining, by the one or more processors, a diameter of a mid-ascending aorta of the aorta image data of a patient and a diameter of sinuses of the aorta image data of a patient; and
calculating, by the one or more processors, the first ratio score based on the diameter of a mid-ascending aorta and the diameter of sinuses.

10. The method of claim 9, further comprising:
classifying, by the one or more processors, the aortic condition of the patient of the patient based on the similarity score and/or the first ratio score.

11. The method of claim 9, further comprising:
determining, by the one or more processors, a second ratio score using the aorta image data, wherein the second ratio score is determined based on the diameter of a mid-ascending aorta and a body surface area of the patient; and
classifying, by the one or more processors, the aortic condition of the patient based on the similarity score, the first ratio score, and/or the second ratio score.

12. The method of claim 1, further comprising:
scaling, by the one or more processors, the similarity score to be in a predefined range of numbers; and
classifying, by the one or more processors, the aortic condition of the patient based on the scaled similarity score.

13. A computer system for classifying an aortic condition of a patient from aorta image data of a patient comprising:
one or more processors; and
a non-transitory program memory coupled to the one or more processors and storing executable instructions that, when executed by the one or more processors, causes the computer system to:
apply the aorta image data to a mesh generator to generate a mesh structure of an aorta of the patient;
determine an intrinsic coordinate system for the mesh structure and determining a plurality of vertices corresponding to the intrinsic coordinate system;
map the mesh structure to a reference coordinate system and generate, from the plurality of vertices corresponding to the intrinsic coordinate system, a plurality of mapped vertices corresponding to the reference coordinate system;
embed the plurality of mapped vertices into the mesh structure to create an embedded mesh structure;
compare the embedded mesh structure to a plurality of reference mesh structures comprising at least one normal aortic mesh structure and at least one pathology aortic mesh structure, where each of the plurality of reference mesh structures correspond to the reference coordinate system, and generate a similarity score indicating a similarity of the embedded mesh structure to at least one of the plurality of reference mesh structures; and
based on the similarity score, classify the aortic condition of the patient.

14. The computer system of claim 13, wherein the instructions, when executed by the one or more processors, further cause the computer system to:
segment the aorta image data of a patient using a segmentation model to determine a segmented aorta image data; and
apply the segmented aorta image data into the mesh generator to determine the mesh structure.

15. The computer system of claim 13, wherein the instructions, when executed by the one or more processors, further cause the computer system to:
apply a surface smoothing algorithm to the mesh structure; and
apply a down-sampling algorithm to the mesh structure.

16. The computer system of claim 13, wherein the instructions, when executed by the one or more processors, further cause the computer system to:
applying a centerline algorithm to the mesh structure to determine an initial mesh centerline;
implement post-processing algorithms to the initial mesh centerline to determine a mesh centerline; and
projecting data of the mesh centerline into the mesh structure.

17. The computer system of claim 13, wherein the instructions, when executed by the one or more processors, further cause the computer system to:
determine a first ratio score using the aorta image data of the patient.

18. The computer system of claim 17, wherein the instructions, when executed by the one or more processors, further cause the computer system to:
determine a diameter of a mid-ascending aorta of the aorta image data of a patient and a diameter of sinuses of the aorta image data of a patient; and
calculate the first ratio score based on the diameter of a mid-ascending aorta and the diameter of sinuses.

19. The computer system of claim 18, wherein the instructions, when executed by the one or more processors, further cause the computer system to:
classify the aortic condition of the patient of the patient based on the similarity score and/or the first ratio score.

20. The computer system of claim 18, wherein the instructions, when executed by the one or more processors, further cause the computer system to:
determine a second ratio score using the aorta image data, wherein the second ratio score is determined based on the diameter of a mid-ascending aorta and a body surface area of the patient; and
classify the aortic condition of the patient based on the similarity score, the first ratio score, and/or the second ratio score.
